(19) United States
(12) Patent Application Publication
(10) Pub. No.: US 2005/0219400 A1
(43) Pub. Date: Oct. 6, 2005

(54) Image quality indicator

(75) Inventor: Anders Poulsen, Holte (DK)

Correspondence Address: LEE & MORSE, P.C., 1101 WILSON BOULEVARD, SUITE 2000, ARLINGTON, VA, 22209, US

(73) Assignee: Hasselblad A/S

(21) Appl. No.: 11/087,722

(22) Filed: Mar. 24, 2005

Related U.S. Application Data
(63) Continuation of application No. PCT/DK03/00615, filed on Sep. 22, 2003.

(30) Foreign Application Priority Data
Sep. 24, 2002 (DK) PA200201409

(51) Int. Cl. H04N 5/228

(52) U.S. Cl. 348/345

(57) ABSTRACT

An electronic camera includes a solid state imaging device and an image processor that calculates a quality parameter and controls signalling of the quality parameter to an operator of the electronic camera. The quality of the recorded image may be determined based on a histogram of image pixel values. A user may be perceptibly warned when the quality parameter is outside a predetermined range.

### CROSS-REFERENCE TO RELATED APPLICATIONS

The present application is a continuation application of International Application No. PCT/DK2003/000615, filed on Sep. 22, 2003, the entire contents of which are incorporated herein by reference for all purposes.

### BACKGROUND OF THE INVENTION

1. Field of the Invention

The present invention relates to electronic cameras having solid state imaging devices, such as CCDs. More particularly, the present invention relates to circuits and techniques for indication of quality of recorded images.

2. Description of Related Art

An electronic still camera employing a CCD includes an automatic exposure control and an automatic focusing control performed by utilizing an image signal derived from the CCD. Exposure control parameters and focusing parameters are automatically determined based on luminance in the image recorded by the CCD.

A CCD is an array of a large number of light sensitive detectors connected to each other as an analog shift register. In each detector of the CCD, a charge is formed that is proportional to the light energy incident on the detector during an integration period. The analog charge of each detector is shifted serially out of the CCD, and is typically converted into a digital value, thus forming a digital representation of the recorded image. Each pixel value of the digital image is equal to the digitized charge of the corresponding CCD detector.

Thus, the image is divided into a large number of segments, denoted pixels, with allocated digital values, denoted pixel values. For example, a grey tone image may be represented digitally by pixels with one respective pixel value representing the grey tone of the corresponding pixel. Similarly, a color image may be represented by pixels having three respective pixel values, one for each of the colors red, green, and blue.

In the present context, the term “exposure” is to be understood in a broad sense as the time period during which an energy sensor is actually sensing the energy. For example, a photographic film is exposed to light whenever light is incident upon it, while a CCD is exposed to light when the pixel elements of the CCD are allowed to integrate light incident upon them.

A color filter mask may be overlaid the CCD array whereby each light sensitive pixel element in the CCD-array is covered with a color filter for passing radiation within a specific spectral range corresponding to a specific primary color, typically red, green and blue. The color filter mask allows a color image to be recorded in a single exposure at the expense of resolution.

It is well-known in the art to automatically adjust focus and exposure of an electronic camera in order to record an image with optimum settings.

However, the photographer is left without an indication of the quality of the image having been recorded.

### SUMMARY OF THE INVENTION

The present invention is therefore directed to an image quality indicator, which substantially overcomes one or more of the problems due to the limitations and disadvantages of the related art.

It is a feature of an embodiment of the present invention to provide an image processor for use with an electronic camera with a solid state imaging device, such as a video camera, a still camera, etc., providing an indication of the quality of a recorded image to the photographer.

At least one of the above and other features and advantages may be realized by providing an image processor for use with an electronic camera having an object lens for focusing an image of an object onto an image plane, and a solid state imaging device positioned at the image plane for conversion of the image into electrical signals. The image processor is adapted for processing the electrical signals into a quality parameter and for controlling signalling of the quality parameter to an operator of the electronic camera.

The image processor may be adapted for calculation of one or more quality parameters, such as luminance, brightness, contrast, color balance, white balance, focus, etc.

The camera may further include an automatic adjustment unit for adjustment of the camera in response to the calculated quality parameters so that a new image recording may be performed with optimum settings of the camera. For example, the camera objective may be focused based on the calculated focus parameter, or a diaphragm may be adjusted in response to the calculated brightness.

Further, one or more of the calculated parameters may be displayed to the operator of the camera, e.g., in the viewer of the camera. Preferably, however, a warning is displayed when at least one of the quality parameters is outside a predetermined desirable range.

In an exemplary embodiment of the present invention, the camera includes a sound reproducing element that is controlled by the image processor for emission of an audible sound when at least one of the quality parameters is outside a predetermined desirable range. The audible sound may be, e.g., a single distinct sound (“bip”) of a specific frequency, a modulated sound, a swept sound, a series of distinct sounds of a specific frequency or of different frequencies, such as a tune, etc, as is well-known in the art of mobile telephones.

A plurality of distinguishable sounds may be related to specific respective qualities of the image. For example, a sound swept from a low frequency to a high frequency may signal that the recorded image is over-exposed while a sound swept from a high frequency to a low frequency may signal that the recorded image is under-exposed.

The image processor may be adapted for calculation of at least one histogram of parameters of a selected color space so that the quality parameter may be calculated based on the at least one histogram.

The camera may further include a selector for user selection of a part of the image, and wherein the quality parameter is calculated based solely on electrical signals from pixels within the selected part of the image. The operator of the camera may select a part of the viewing field to form the basis for the quality parameter determination, e.g., a central part of the viewing field.

### BRIEF DESCRIPTION OF THE DRAWING

The above and other features and advantages of the present invention will become more apparent to those of ordinary skill in the art by describing in detail exemplary embodiments thereof with reference to the attached drawings in which:

FIG. 1 is a schematic block diagram of an electronic camera according to the present invention,

FIG. 2 is a grey-scale image, and

FIG. 3 is a histogram of the grey-scale image of FIG. 2.

### DETAILED DESCRIPTION OF THE INVENTION

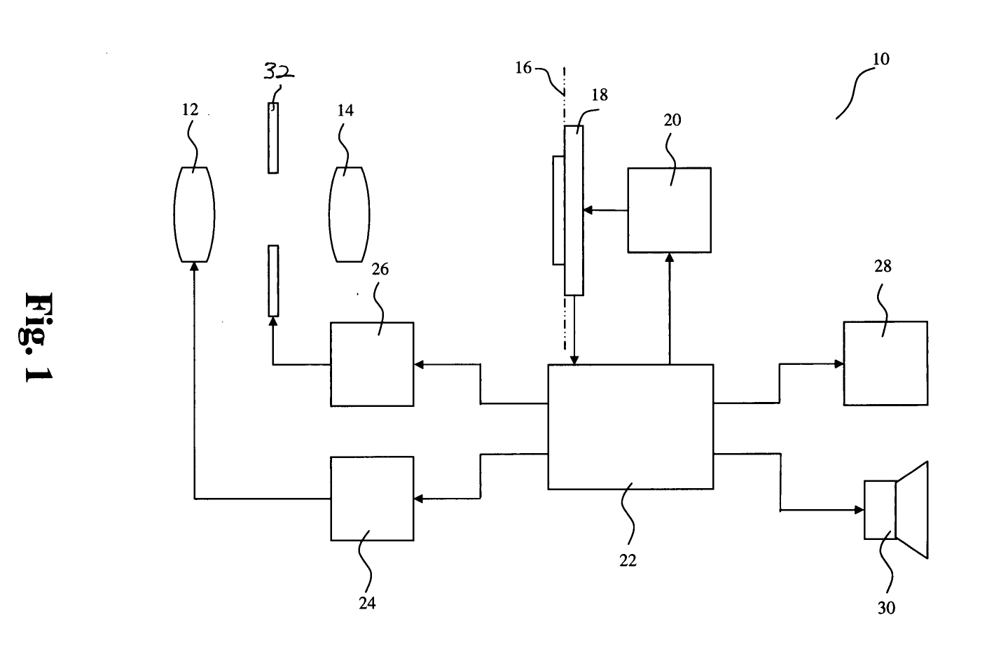

The operational principles of the invention will now be explained with reference to FIG. 1. FIG. 1 is a schematic block diagram of an electronic camera 10 according to the present invention. The electronic camera 10 includes a movable object lens 12, a second lens 14, an image plane 16, a CCD 18, a CCD driver 20, an image processor 22, a lens drive motor 24, a diaphragm 32, a diaphragm drive motor 26, a field 28 of a viewer, and a sound reproducing element 30.

The movable object lens 12 focuses an image of an object (not shown) in cooperation with the second lens 14 onto the image plane 16, which coincides with the light sensitive surfaces of the array of light sensitive sensors of the CCD 18. The image recording of the CCD 18 is controlled by the CCD driver 20 that enables and disables integration of light by the CCD light sensors. The CCD driver 20 also controls shifting of the accumulated charges out of the CCD 18 thereby forming the electrical signals. The electrical signals are received by the image processor 22 that composes a digital image based on the electrical signals and also calculates quality parameters of the image. These quality parameters may include, for example, a focus parameter value and a brightness parameter value. Based on a focus parameter value, the lens drive motor 24 is controlled to move the objective lens 12 to focus the image. Based on a brightness parameter value, the diaphragm drive motor 26 is controlled to adjust the aperture of the diaphragm 32, and the integration time period of the CCD is controlled for optimum exposure of the next image.

The field 28 of the viewer is controlled by the image processor 22 to display an image, and may display a value of the calculated quality parameters, or at least a warning signal when at least one of the calculated quality parameters is outside predetermined respective desired ranges. The warning signal displayed may vary in accordance with which quality parameter is outside a respective desired range, as well as the degree to which the quality parameter is outside the respective desired range.

The sound reproducing element 30 is also controlled by the image processor 22, and emits an audible sound when at least one of the quality parameters is outside a predetermined desirable range. The audible sound emitted by the sound reproducing element 20 may vary in accordance with which quality parameter is outside a respective desired range, as well as the degree to which the quality parameter is outside the respective desired range. In other words, a plurality of distinguishable sounds may be related to specific respective qualities of the image. The audible sound may be, e.g., a single distinct sound (“bip”) of a specific frequency, a modulated sound, a swept sound, a series of distinct sounds of a specific frequency or of different frequencies, such as a tune, etc, as is well-known in the art of mobile telephones. For example, a sound swept from a low frequency to a high frequency may signal that the recorded image is over-exposed, while a sound swept from a high frequency to a low frequency may signal that the recorded image is under-exposed.

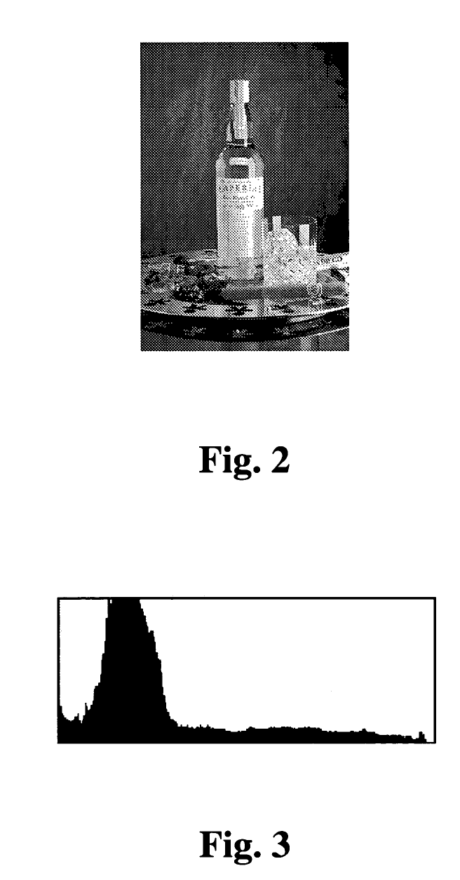

The quality factors may be calculated from a histogram of a recorded image as illustrated in FIGS. 2 and 3. For example, in an over-exposed image, the histogram-distribution will move to the right and pixels will be missing at the low end of the histogram, and, in an under-exposed image, the histogram-distribution will move to the left and pixels will be missing at the high end of the histogram. The user may select only part of the image to be analyzed by the image processor 22. This selection may be performed on the field 28 of the viewer.

Thus, in accordance with an embodiment of the present invention, an image processor in an electronic camera may calculate an image quality parameter based on a histogram for the image. The image processor may control the output a perceptible warning signal to a user when the image quality parameter is outside a predetermined range. This perceptible warning signal may be, for example, visible or audible. The perceptible warning signal may indicate at least one of a degree and direction from which the image quality parameter deviates from the predetermined range.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. An image processor for use with an electronic camera having an object lens for focusing an image of an object onto an image plane and a solid state imaging device positioned at the image plane for conversion of the image into electrical signals,
the image processor being adapted for processing the electrical signals into an image quality parameter based on calculation of a histogram for the image, and for controlling signalling of the image quality parameter to an operator of the electronic camera.

2. The image processor as claimed in claim 1, wherein the image quality parameter is based on at least one parameter selected from the group consisting of luminance, brightness, contrast, color balance, white balance, and focus.

3. The image processor as claimed in claim 2, wherein the image quality parameter is based on luminance values from pixels of the solid state imaging device.

4. The image processor as claimed in claim 2, wherein the image processor is adapted for calculation of at least one histogram of parameters of a selected color space and wherein the image quality parameter is calculated based on the at least one histogram.

5. The image processor as claimed in claim 2, further comprising a selector for user selection of a part of the image, and wherein the image quality parameter is calculated based solely on electrical signals from pixels within the selected part of the image.

6. The image processor as claimed in claim 2, wherein the image processor is further adapted for controlling a sound reproducing element for emission of a warning sound when the image quality parameter is below a predetermined threshold.

7. The image processor as claimed in claim 2, wherein the image processor is further adapted for controlling a visual display element for displaying a warning when the image quality parameter is below a predetermined threshold.

8. The image processor as claimed in claim 7, wherein the visual display element resides in a viewer of the electronic camera.

9. The image processor as claimed in claim 1, wherein the image processor is adapted for calculation of at least one histogram of parameters of a selected color space and wherein the image quality parameter is calculated based on the at least one histogram.

10. The image processor as claimed in claim 1, further comprising a selector for user selection of a part of the image, and wherein the image quality parameter is calculated based solely on electrical signals from pixels within the selected part of the image.

11. The image processor as claimed in claim 1, wherein the image processor is further adapted for controlling a sound reproducing element for emission of a warning sound when the image quality parameter is below a predetermined threshold.

12. The image processor as claimed in claim 1, wherein the image processor is further adapted for controlling a visual display element for displaying a warning when the image quality parameter is below a predetermined threshold.

13. The image processor as claimed in claim 12, wherein the visual display element resides in a viewer of the electronic camera.

14. The image processor as claimed in claim 1, wherein the image processor is further adapted to output a perceptible warning signal to a user when the image quality parameter is outside a predetermined range.

15. The image processor as claimed in claim 14, wherein the perceptible warning signal further indicates at least one of a degree and direction from which the image quality parameter deviates from the predetermined range.

16. The image processor as claimed in claim 15, wherein the perceptible warning signal is audible.

17. The image processor as claimed in claim 1, wherein the image processor is further adapted to move the object lens in accordance with the image quality parameter.

18. An electronic camera comprising:
an object lens for focusing an image of an object onto an image plane;
a solid state imaging device positioned at the image plane for conversion of the image into electrical signals; and
an image processor, the image processor being adapted for processing the electrical signals into an image quality parameter based on calculation of a histogram for the image, and for controlling signalling of the image quality parameter to an operator of the electronic camera.

19. The electronic camera as claimed in claim 18, wherein the image processor is further adapted to output a perceptible warning signal to a user when the image quality parameter is outside a predetermined range.

20. The electronic camera as claimed in claim 19, wherein the perceptible warning signal further indicates at least one of a degree and direction from which the image quality parameter deviates from the predetermined range.
